(19) United States
(12) Patent Application Publication
(10) Pub. No.: US 2004/0170449 A1
(43) Pub. Date: Sep. 2, 2004

(54) Developing roller and image forming device

(75) Inventors: Junji Sakata, Kodaira-shi (JP); Takayuki Sugimura, Kodaira-shi (JP); Kouji Takagi, Kodaira-shi (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION

(21) Appl. No.: 10/730,248

(22) Filed: Dec. 9, 2003

(30) Foreign Application Priority Data
Dec. 10, 2002 (JP) 2002-358253

(51) Int. Cl. G03G 15/08

(52) U.S. Cl. 399/286

(57) ABSTRACT

A developing roller and an image forming device capable of securely obtaining high-quality images are provided. In the developing roller having at least one resin outer layer 3a formed on the outer periphery of an elastic layer 3, the resin outer layer is made of an ultraviolet-curable resin or an electron-beam-curable resin. The resin outer layer 3a contains fine particles of which mean particle diameter is 1-50 μm and a conductive agent such as an ionic conductive agent or an electronic conductive agent. Preferably used as the fine particles are silicone rubber, fluororubber, melamine resin, phenol resin, glassy carbon, urethane elastomer, and the like. The ratio of the mean particle diameter “a” of the fine particles and the thickness “b” of the resin outer layer 3a, i.e. “a/b”, is preferably in a range of 0.05 to 0.5.

### FIELD OF THE INVENTION

The present invention relates to a developing roller to be used in an image forming device such as an electrophotographic device or an electrostatic recording device e.g. a copying machine or a printer, and to an image forming device using this developing roller.

### BACKGROUND OF THE INVENTION

In an image forming device of an electrophotographic system such as a copying machine or a printer, toner (non-magnetic single-component developer) is supplied to a photosensitive drum carrying a latent image thereon so that the developer is attracted to the latent image on the photosensitive drum to form a visible toner image. As one of the developing method, the contact development is well known.

The contact development is a method of conducting development by bringing a developing roller holding toner into contact with a latent image carrier (image forming member) such as a photosensitive drum carrying an electrostatic latent image thereon whereby the toner is attracted to the latent image on the latent image carrier. Therefore, the developing roller must be formed of an elastic member having conductivity.

The contact development will be described with reference to FIG. 2 as an illustrative example. A developing roller 1 as mentioned above is arranged between a toner applying roller 4 for supplying toner and the photosensitive drum (image forming member) 5 carrying an electrostatic latent image thereon. As the developing roller 1, the photosensitive drum 5, and the toner applying roller 4 are rotated in directions of arrows in FIG. 2, respectively, the toner 6 is supplied to a surface of the developing roller 1 by the toner applying roller 4 and the toner is regulated into a uniform thin layer by a layer regulating blade 7. As the developing roller 1 is rotated in this state with being contact with the photosensitive drum 5, the toner regulated in the thin layer is attracted from the developing roller 1 to the latent image on the photosensitive drum 5, thereby forming a visible toner image. In FIG. 2, numeral 8 designates a transfer portion where the toner image is transferred to a recording medium such as paper, and numeral 9 designates a cleaning portion where toner remaining on the surface of the photosensitive drum 5 after transfer is removed by a cleaning blade 10.

The developing roller 1 must be securely held in closely contact with the photosensitive drum 5 while rotating. For this, as shown in FIG. 1, the developing roller 1 has a structure having a semi-conductive elastic layer 3 which is formed around the outer periphery of a shaft 2 made of a highly conductive material such as a metal. The semi-conductive elastic layer 3 is formed of a semi-conductive elastic member made from an elastomer such as silicone rubber, NBR, EPDM, ECO, or polyurethane to which carbon black or a metal powder is dispersed or a foamed member obtained by foaming the elastomer. In some cases, a resin outer layer 3a is formed on the surface of the semi-conductive elastic layer 3 for controlling the charging and adhesion characteristics to the toner, controlling a friction force between the developing roller 1 and the layer regulating blade 7, and/or preventing the photosensitive drum 5 from being contaminated by the elastic member of the developing roller 1.

As a method of forming this resin outer layer 3a, a method by dipping a roller into a solvent paint or a water paint or spraying such a paint onto the roller and, after that, drying and hardening the paint with heat or hot air has been employed. However, this method requires prolonged drying so that, a long drying line is needed for mass production. Since the solid layer of the roller requires delicate conductivity and surface condition according to its use application. In the long drying line, variation in temperature distribution and variation in airflow volume affect the property. That is, there are problems about cost and quality.

To solve these problems, JP2002-310136A discloses a developing roller having a resin outer layer which is formed by applying and curing an ultraviolet-curable resin. This publication discloses a method of forming an elastic layer by pouring urethane raw material into a cylindrical mold and foaming and curing the urethane raw material to form an elastic layer, and forming a resin outer layer on the outer periphery of the elastic layer without grinding the surface of the elastic layer.

It is important to hold a predetermined amount of toner on the peripheral surface of the developing roller evenly.

The amount of toner on the surface of the roller mainly depends on the adhesion force according to electrical image force due to charge of charged toner and on the mechanical carrying force by roughness formed on the surface of the roller.

Controlling the amount of toner carried by the fine roughness of the surface of the roller is a key point for ensuring the well development characteristics.

In a conventional method of manufacturing developing rollers, a substrate is formed into a roller shape by grinding so that the grinded surface has suitably-sized roughness. As a coating layer is formed like a membrane on the grinded surface, suitably-sized roughness is formed on the surface of a resin outer layer.

As a more productive manufacturing method, there is a need for a method of manufacturing a roller substrate without grinding process. As one of this manufacturing method, JP2002-310136A discloses a method of using, as the substrate, a roller formed by using a mold without any process. The peripheral surface of an elastic layer formed according to this method is a smooth surface similar to the inner surface of the mold.

When a resin outer layer is formed on the elastic layer having the smooth peripheral surface, the surface of the resin outer layer is also smooth so that the toner carrying characteristics should be poor.

### SUMMARY OF THE INVENTION

It is an object of the present invention to provide a developing roller having a resin outer layer formed on a smooth periphery of an elastic member, wherein the resin outer layer has fine roughness and to provide an image forming device with this developing roller.

A developing roller of the present invention is characterized by comprising a shaft, an elastic layer formed on the outer periphery of the shaft, and at least one resin outer layer formed on the outer periphery of the elastic layer, wherein fine particles are dispersed in the resin outer layer.

An image forming device of the present invention is characterized by comprising this developing roller.

Since the resin outer layer contains fine particles, the developing roller of the present invention has fine roughness on the outer periphery thereof due to the fine particles. This enables the developing roller to uniformly hold a predetermined amount of toner on the outer periphery thereof.

The elastic layer of the developing roller is molded by using a mold. It is preferable to form the resin outer layer without grinding the outer surface of the elastic layer.

The resin outer layer contains a conductive agent, thereby reducing the electric resistance of the resin outer layer and improving the development characteristics.

### BRIEF DESCRIPTION OF THE DRAWINGS

FIG. 1 is a sectional view of a developing roller; and

FIG. 2 is a structural illustration of an image forming device.

### DESCRIPTION OF THE PREFERRED EMBODIMENTS

A toner carrier according to an embodiment of the present invention comprises a highly conductive shaft 2, a semi-conductive elastic layer 3 formed on the outer periphery of the shaft 2, and a semi-conductive resin outer layer 3a formed on the semi-conductive elastic layer 3.

The shaft 2 may be any of shafts having high electrical conductivity and normally is a metallic shaft such as a solid shaft and a hollow shaft having a bore inside, which is made of a metal such as iron, stainless steel, aluminum and the like.

The semi-conductive layer 3 formed on the outer periphery of the shaft 2 is a semi-conductive elastic member such as an elastomer or a foamed member obtained by foaming the elastomer to which an electronic conductive agent such as carbon black or an ionic conductive agent such as sodium perchlorate is added for controlling the resistivity of the semi-conductive elastic member.

Specific examples of the elastomer include silicone rubber, EPDM, NBR, natural rubber, SBR, butyl rubber, chloroprene rubber, acrylic rubber, epichlorohydrin rubber, EVA, polyurethane, and mixtures thereof. In particular, silicone rubber, EPDM, epichlorohydrin rubber, and polyurethane are preferably used. The elastomer may be used as a foamed member obtained by chemically foaming the elastomer with a foaming agent, or a foamed member such as a polyurethane foam obtained by mechanically entraining air in the elastomer. In the present invention, so-called RIM (reaction injection molding) may be employed in a forming process for integrating the shaft 2 and the elastic layer 3. That is, two kinds of monomer components composing the raw material of the elastic layer 3 are mixed and injected into a cylindrical mold so that the mixed material is foamed at the same time as the polymerization reaction, thereby integrating the shaft 2 and the elastic layer 3. According to this, the forming process takes only about 60 seconds from injection of materials to the stripping from the mold, thereby significantly reducing the production cost.

The conductive agent to be added to the semi-conductive elastic layer 3 may be an electronic conductive agent or an ionic conductive agent.

Specific examples of the electronic conductive agent include conductive carbons such as ketchen black and acetylene black; carbons usually used as an additive for rubber such as SAF, ISAF, HAF, FEF, GPF, SRF, FT and MT; oxidized carbons usually used as a coloring agent for ink; pyrolytic carbon; natural graphite; artificial graphite; metals or metal oxides such as antimony doped tin oxide, titanium oxide, zinc oxide, nickel, copper, silver, and germanium; conductive polymers such as polyaniline, polypyrrole, and polyacetylene; and conductive whiskers such as carbon whisker, graphite whisker, titanium carbide whisker, conductive potassium titanate whisker, conductive barium titanate whisker, conductive titanium oxide whisker, and conductive zinc oxide whisker. The added amount of the electronic conductive agent is usually in a range of 1 to 50 parts by weight, preferably, 5 to 40 parts by weight relative to 100 parts by weight of the above elastomer.

Specific examples of the ionic conductive agent include ammonium salts, for example, a perchlorate, chlorate, hydrochloride, bromate, iodate, hydroborofluoride, sulfate, ethylsulfate, carboxylate, and sulfonate of tetraethyl ammonium, tetrabutyl ammonium, dodecyltrimethyl ammonium, hexadecyltrimethyl ammonium, benzyltrimethyl ammonium, and denatured fatty acid dimethylethyl ammonium; and metal salts, for example, a perchlorate, chlorate, hydrochloride, bromate, iodate, hydroborofluoride, sulfate, trifluoromethyl sulfate, and sulfonicacid salt of an alkali metal such as lithium, sodium, or potassium, and an alkali earth metal such as calcium or magnesium. The added amount of the ionic conductive agent is usually in a range of 0.01 to 10 parts by weight, preferably, 0.05 to 5 parts by weight relative to 100 parts by weight of the above elastomer.

The above conductive agents may be added singly or in combination of two kinds or more. In this case, the electronic conductive agent and ionic conductive agent may be combined with each other.

Though there is no particular limitation on the resistance value of the semi-conductive elastic layer 3, it is preferable to set the resistance value in a range of 10³ to 10¹⁰ Ωcm, more preferably, 10⁴ to 10⁸ Ωcm, by adding the above conductive agent. If the resistance value is less than 10³ Ωcm, charges may leak to a photosensitive drum or the toner carrier itself may be broken due to the voltage applied thereto, while if it exceeds 10¹⁰ Ωcm, fog on the ground easily occurs.

To the semi-conductive elastic layer 3, a crosslinking agent or a vulcanizing agent can be added as required for converting the elastomer into a rubber-like substance. In the case of either organic peroxide crosslinking or sulfur crosslinking, a vulcanization assistant, vulcanization accelerator, vulcanization activator, and/or vulcanization retarder may be used. In addition to the above additives, a peptizer, foaming agent, plasticizer, softener, tackifier, antitack agent, separating agent, mold releasing agent, filler, and coloring agent, which are generally used as additives for rubber, may be added to the semi-conductive elastic layer 3.

In the case where the semi-conductive elastic layer 3 is made by using polyurethane or EPDM as the substrate, a charge control agent such as Nigrosine, triaminophenylmethane, or cation dye; and a fine powder of silicone resin, silicone rubber, or nylon can be added to the polyurethane or EPDM for controlling the charged amount of toner on the surface of a developing roller. The added amount of the charge control agent is preferably in a range of 1 to 5 parts by weight relative to 100 parts by weight of polyurethane or EPDM, and the added amount of the fine powder is preferably in a range of 1 to 10 parts by weight relative to 100 parts by weight of polyurethane or EPDM.

Though there is no particular limitation on the hardness of the semi-conductive elastic layer 3, it is preferable to set the semi-conductive elastic layer 3 to have an Asker C hardness of 80 degrees or less, particularly, 40 to 70 degrees. In the case of using the semi-conductive elastic layer 3 for a developing roller, if the hardness is more than 80 degrees, the contact area between the developing roller and a photosensitive drum becomes small, obstructing desirable development. Further, the toner may be damaged by the developing roller and may stick to the photoreceptor or the layer regulating blade, to thereby easily cause an image failure. If the hardness is excessively low, a friction force between the roller and the photoreceptor or the layer regulating blade becomes large, resulting in an image failure such as jitter.

Since the semi-conductive elastic layer 3 is used in the state being in contact with the photoreceptor and the layer regulating blade, even when the hardness of the semi-conductive elastic layer 3 is set to be low, a compression set thereof is preferably set as small as possible, concretely, in a range of 20% or less.

Though there is no particular limitation on the surface roughness of the semi-conductive elastic layer 3, it may be in a range of 15 μmRz or less, preferably, 1 to 10 μmRz in JIS 10-Point Average Roughness. If the surface roughness is more than 15 μmRz, it often fails to ensure the uniformity in layer thickness of a mono-component developer (toner) and the uniformity in charging of the toner. On the contrary, by specifying the surface roughness in the range of 15 μmRz or less, it is possible to improve the adhesion of the toner, and also to certainly prevent the degradation of an image due to wear of the roller caused by long-term use.

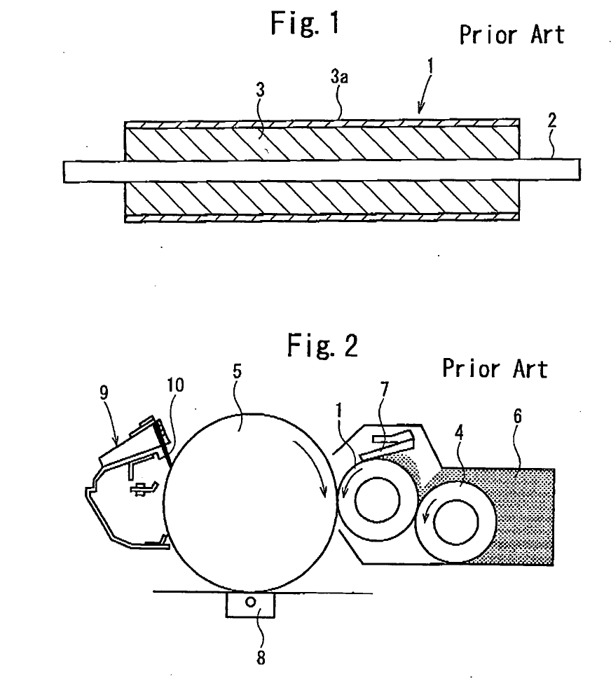

As for the developing roller of this embodiment, as shown in FIG. 1, the resin outer layer 3a is formed on the semi-conductive elastic layer 3 by curing an ultraviolet-curable resin or an electron-beam-curable resin for adjusting the resistance and controlling the charge and the supply amount of toner. Specific examples of the ultraviolet-curable resin or the electron-beam-curable resin include polyester resin, polyether resin, fluoroplastic, epoxy resin, amino resin, polyamide resin, acrylic resin, acrylic urethane resin, urethane resin, alkyd resin, phenol resin, melamine resin, urea resin, silicone resin, and polyvinyl butyral resin. These may be used singly or in combination of two kinds or more. Further, a denatured resin in which a specific functional group is introduced into one or more of the aforementioned resins may be used.

It is preferable to introduce a cross-linking structure to the resin outer layer 3a in order to improve the mechanical strength and the environmental resistance of the resin outer layer 3a.

Though there is no particular limitation on the ultraviolet-curable resin or the electron-beam-curable resin, a resin composition of (meth)acrylate series including a (meth)acrylate oligomer is preferably used.

Examples of the (meth)acrylate oligomer include urethane (meth)acrylate oligomers, epoxy (meth)acrylate oligomers, ether (meth)acrylate oligomers, ester (meth)acrylate oligomers, and polycarbonate (meth)acrylate oligomers. Besides these, a fluorine acrylic oligomer or a silicone acrylic oligomer may also be used.

The above (meth)acrylate oligomer is obtained by reaction of polyethylene glycol, polyoxyproplylene glycol, polytetramethylene ether glycol, bisphenol A based epoxy resin, epoxy phenolic novolac resin, or a compound of polyhydric alcohol and adducts of E-caprolactone and (meth)acrylic acid, or is obtained by converting a polyisocyanate compound and a hydroxy (meth)acrylate compound into urethane.

The urethane (meth)acrylate oligomer is obtained by converting a polyol compound or an isocyanate compound and a hydroxy (meth)acrylate compound into urethane.

Examples of the epoxy (meth)acrylate oligomer include reaction products of a compound having a glycidyl group and (meth) acrylic acid. Among such reaction products, a reaction product of a compound, having a ring structure such as a benzene ring, a naphthalene ring, a spiro ring, a dicyclopentadiene, or a tricyclodecane in addition to a glycidyl group, and (meth)acrylic acid is preferably used.

The ether (meth)acrylate oligomers, the ester (meth)acrylate oligomers, and the polycarbonate (meth)acrylate oligomers can be obtained by reaction between polyols (polyether polyol, polyester polyol, and polycarbonate polyol) and (meth) acrylic acid, respectively.

If needed, a reactive diluent having polymerizable doule bond is added into the resin compound in order to adjust the viscosity. For example, the reactive diluent may be a monofunctional, difunctional, or multifunctional polymerizable compound having a structure in which (meth) acrylic acid is combined to a compound containing amino acid or hydroxyl by esterification reaction and amide forming reaction. The added amount of the diluent is normally preferably in a range of 10 to 200 parts by weight relative to 100 parts by weight of the (meth)acrylate oligomer.

In this embodiment of the present invention, fine particles are dispersed into the resin outer layer 3a to form roughness in the surface of the resin outer layer 3a.

Preferably used as the fine particles are fine particles of a rubber or a synthetic resin, or carbon fine particles. More concretely, fine particles of one kind or a mixture of two kinds or more selected from a group consisting of silicone rubber, fluoroplastic, urethane elastomer, urethane acrylate, melamine resin, phenol resin, and glassy carbon are preferable.

The added amount of fine particles is in a range of 0.1 to 100 parts by weight, preferably, 5 to 80 parts by weight relative to 100 parts by weight of the resin.

The mean particle diameter of the fine particles is suitably in a range of 1 to 50 μm, particularly, 3 to 20 μm. The ratio “a/b” between the mean particle diameter “a” (μm) and the thickness “b” (μm) of the resin outer layer 3a is in a range of 0.03 to 0.5, preferably, 0.05 to 0.4. The thickness “b” of the resin outer layer is preferably in a range from 1 to 100 μm as will be described later. By setting the ratio “a/b” in the above-mentioned range, proper fine roughness can be formed on the surface of the resin outer layer 3a.

A conductive agent may be added to the material of the resin outer layer 3a for controlling the conductivity of the resin outer layer 3a. Examples of the conductive agent are the same as listed as the examples of the conductive agent to be used in the above-described semi-conductive elastic layer 3.

The added amount of the conductive agent in the resin outer layer 3a is in a range of 20 parts by weight or less, preferably 0.01 to 20 parts by weight, more preferably 1 to 10 parts by weight relative to 100 parts by weight of the resin.

As a transparent conductive agent such as metal or metal oxide e.g. tin oxide, titanium oxide, zinc oxide, potassium titanate, barium titanate, nickel, and copper is used as the conductive agent, transmission of ultraviolet rays is easily allowed, thus preventing the interference with polymerization of an ultraviolet-curable resin. The added amount of the transparent conductive agent is in a range of 100, parts by weight or less, preferably 1 to 80 parts by weight, more preferably 10 to 50 parts by weight relative to 100 parts by weight of resin.

When an ultraviolet-curable resin is used as the resin of the resin outer layer, it is preferable to contain a polymerization initiator. Examples of the ultraviolet polymerization initiator are various polymerization initiators, for example, 4-dimethylaminobenzoic acid, 4-dimethylaminobenzoic ester, 2,2-dimethoxy-2-phenylacetophenone, acetophenone diethylketal, alkoxyacetophenone, benzyldimethylketal, benzophenone, benzophenone derivatives such as 3,3-dimethyl-4-methoxy benzophenone, 4,4-dimethoxy benzophenone, and 4,4-diamino benzophenone, benzoylbenzoic acid alkyl, bis (4-dialkylaminophenyl) ketone, benzyl, benzyl derivatives such as benzyl methylketal, benzoin, benzoin derivatives such as benzoin isobutyl ether, benzoin isopropyl ether, 2-hydroxy-2-methyl propiophenone, 1-hydroxycyclohexyl phenylketone, xanthone, thioxanthone, thioxanthone derivatives, fluorine, 2,4,6-trimethylbenzoyldiphenylphosphine oxide, bis(2,6-dimethoxybenzoyl)-2,4,4-trimethylpentylphosphine oxide, bis(2,4,6-trimethylbenzoyl)-phenylphosphine oxide, and 2-methyl-1-[4-(methylthio)phenyl]-2-morpholino propanone-1,2-benzyl-2-dimethylamino-1-(morpholinophenyl) -buthane-1. These may be used singly or in combination of two kinds or more.

The added amount of the ultraviolet polymerization initiator is preferably in a range of 0.1 to 10 parts by weight relative to 100 parts by (meth)acrylate oligomer.

In the present invention, besides the essential components, a tertiary-degree amine such as triethylamine or triethanolamine, an alkyl phosphine photo-polymerization accelerator such as triphenyl phosphine, or a thioether photo-polymerization accelerator such as p-thiodiglycol may be added in order to accelerate the photo polymerization by the photo-polymerization initiator, if necessary. The added amount of the compound is normally preferably in a range of 0.01 to 10 parts by weight relative to 100 parts by weight of (meth)acrylate oligomer.

Besides the aforementioned additives, various additives may be added into the resin outer layer 3a, if necessary.

Preferably employed as the method of forming the resin outer layer 3a on the semi-conductive elastic layer 3 is a method in which coating liquid of a composition consisting of the aforementioned resin and the additive(s) is applied onto the semi-conductive elastic layer 3 and then irradiated with ultraviolet rays or electron beams. The coating liquid preferably does not contain a solvent.

As the method of applying the coating liquid, spraying method, roll-coating method, or dipping method may be employed.

Though there is no particular limitation on the thickness of the resin outer layer 3a, the thickness is normally in a range of 1 to 100 μm, preferably, 3 to 100 μm, more preferably, 5 to 100 μm. If the thickness is less than 1 μm, the enough charging property of the surface layer may be not ensured due to friction during operation. On the other hand, if the thickness exceeds 100 μm, the surface of the developing roller is so hard to damage toner, producing sticking of toner on the image forming drum and/or the layer regulating blade and thus causing an image failure.

The electric resistance of the developing roller according to the present invention is preferably in a range of 10³ to 10¹⁰ Ω, more preferably, 10⁴ to 108 Ω. If the resistance value is less than 10³ Ω, the tone control becomes quite difficult. In addition, when the image forming member such as a photoreceptor has a defect, bias leakage may occur. On the other hand, if the resistance value exceeds 1010 Ω, when a latent image on the latent image carrier such as a photoreceptor is developed with toner, a development bias must be subjected to voltage drop because of the high resistance of the toner carrier itself so that it is impossible to ensure development bias enough for development, thus leading to insufficient image density. The resistance value can be measured from a current value which is obtained by pressing the outer surface of the developing roller to a plate-like or cylindrical antipole with a predetermined pressure and applying a voltage of 100 V between the shaft and the antipole.

It is important to properly and uniformly control the resistance value of the developing roller in view of properly and uniformly maintaining the electric field intensity for transferring toner.

The developing roller of this embodiment of the present invention can be adopted to an image forming device using toner. Specifically, as shown in FIG. 2, a developing roller 1 of this embodiment of the present invention is arranged between a toner applying roller 4 for supplying toner and a photosensitive drum 5 for carrying an electrostatic latent image such that the developing roller 1 is in contact with or in proximity to the photosensitive drum 5. Toner 6 is supplied from the toner applying roller 4 onto the developing roller 1 and is regulated into a uniform thin layer by a layer regulating blade 7. Further, the toner is supplied from the thin layer onto the photosensitive drum 5 so that the toner is attracted to the latent image on the photosensitive drum 5, thereby forming a visible toner image. It should be noted that the details of FIG. 2 have been already explained in the paragraph concerning the related art and the explanation is therefore omitted.

### EXAMPLES AND COMPARATIVE EXAMPLES

The present invention will be more clearly described by way of the following examples and comparative examples. However, the present invention is not limited to the following examples.

### Example 1

A mixture consisting of 100 parts by weight of SANNIX FA952 (polyether polyol available from Sanyo Chemical Industries, Ltd., OH value=37), 1 part by weight of SRX274C (foaming agent available from Dow Corning Toray Silicone Co., Ltd.), 2.8 parts by weight of TOYOCAT NP (amine catalyst available from TOSOH CORPORATION), 1.5 parts by weight of TOYOCAT EP (amine catalyst available from TOSOH CORPORATION), and 59 parts by weight of SANFOAM IC-716 (tolylene diisocyanate available from Sanyo Chemical Inductries, Ltd.) was mechanically agitated and thus foamed.

A metallic shaft which was 6.0 mm in outer diameter and 240 mm in length was inserted into a metallic cylindrical mold having a surface treated with fluorine which was 16 mm in inner diameter and 250 mm in length through its opening formed in one end and the aforementioned foamed polyurethane raw material was injected from a foaming machine for RIM

(Reaction Injection Molding).

Then, the mold filled with the foamed polyurethane raw material was cured in an oven at a temperature of 80° C. for 20 minutes. After that, the mold was released, thereby obtaining a roller body having an outer diameter of 12 mm and an elastic layer of 210 mm in entire length.

As shown in Table 1, an urethane ultraviolet-curable resin composition consisting of 20 PHR of silicone rubber fine particles of which mean particle diameter 8 μm (Range of particle diameters: 1-15 μm. In Tables 1 through 3, values between parentheses are the ranges of particle diameters) and 2 PHR of sodium perchlorate as the ion conductive agent was applied to the outer peripheral surface of the roller body by a roll coater to have a thickness of 100 μm and was then irradiated with ultraviolet rays at 400 mW of illumination intensity and at 1000 mJ/cm² in cumulative amount of light with rotating the roller by UNICURE UVH-0252C available from USHIO INC., so that the coating layer was cured instantaneously, thereby forming a resin outer layer having elasticity.

The obtained roller had characteristics shown in Table 1 and can be suitably used as a developing roller.

### Example 2

A developing roller was manufactured in the same manner as Example 1 except that the elastic layer was made of urethane elastomer. This developing roller had characteristics shown in Table 1 and also can be suitably used as a developing roller.

### Example 3

A developing roller was manufactured in the same manner as Example 1 except that 20 PHR of fluoroplastic fine particles was added as fine particles. This developing roller had characteristics shown in Table 1 and also can be suitably used as a developing roller.

### Example 4

A developing roller was manufactured in the same manner as Example 1 except that 20 PHR of melamine resin pulverized particles was added as fine particles. This developing roller had characteristics shown in Table 1 and also can be suitably used as a developing roller.

### Example 5

A developing roller was manufactured in the same manner as Example 1 except that 20 PHR of phenol resin fine particles was added as fine particles. This developing roller had characteristics shown in Table 2 and also can be suitably used as a developing roller.

### Example 6

A developing roller was manufactured in the same manner as Example 1 except that 20 PHR of glassy carbon was added as fine particles. This developing roller had characteristics shown in Table 2 and also can be suitably used as a developing roller.

### Example 7

A developing roller was manufactured in the same manner as Example 1 except that 20 PHR of urethane resin (elastomer) fine particles was added as fine particles. This developing roller had characteristics shown in Table 2 and also can be suitably used as a developing roller.

### Example 8

A developing roller was manufactured in the same manner as Example 1 except that 20 PHR of carbon black was added as the conductive agent and the curing was conducted by electron beam irradiation. This developing roller had characteristics shown in Table 2 and also can be suitably used as a developing roller.

### Comparative Example 1

A developing roller was manufactured in the same manner as Examples 1 through 4 except that no fine particles were added. As shown in Table 3, the amount of toner carried by this roller was small, thus leading to poor image quality. The durability of the roller was also lower than that of any of Examples.

### Comparative Example 2

A developing roller was manufactured in the same manner as Example 2 except that the mean particle diameter of the fine particles was 130 μm and the thickness of the resin outer layer was 200 μm. As shown in Table 3, both the image quality and the durability of the roller were lower than any of Examples.

### Comparative Example 3

A developing roller was manufactured in the same manner as Example 4 except that the mean particle diameter of the fine particles was 0.8 μm. As shown in Table 3, both the image quality and the durability of the roller were lower than any of Examples.

### Comparative Example 4

A developing roller was manufactured in the same manner as Example 5 except that the added amount of the fine particles was 120 PHR. As shown in Table 3, both the image quality and the durability of the roller were lower than any of Examples. The viscosity of raw material for forming a resin coating layer was too high, so it was difficult to uniformly apply the raw material.

### Comparative Example 5

A developing roller was manufactured in the same manner as Example 6 except that the added amount of the fine particles was 0.08 PHR. As shown in Table 3, both the image quality and the durability of the roller were lower than any of Examples.

TABLE 1

| | | Example 1 | Example 2 | Example 3 | Example 4 |
|---|---|---|---|---|---|
| Elastic Layer | Resin | Foamed RIM | Urethane | Foamed RIM | Foamed RIM |
| | | urethane | Elastomer | urethane | urethane |
| | Resin Resistance [Ω cm] | 1.00E+07 | 1.00E+07 | 1.00E+07 | 1.00E+07 |
| | Thickness [mm] | 4 | 4 | 4 | 4 |
| Resin Outer Layer | Resin | Polyurethane | Polyurethane | Polyurethane | Polyurethane |
| | | Acrylate | Acrylate | Acrylate | Acrylate |
| | Conductive Agent | NaClO₄ | NaClO₄ | NaClO₄ | NaClO₄ |
| | | 2phr | 2phr | 2phr | 2phr |
| | Fine Particles | Silicone Rubber, | Silicone Rubber, | Fluoroplastic, | Melamine Resin |
| | | TOREFILL E- | TOREFILL E- | RUBRON L-5 | Pulverized |
| | | 500 from Dow | 500 from Dow | from Daikin | Particles |
| | | Corning Toray | Corning Toray | Industries, Ltd. | |
| | | Silicone Co., Ltd. | Silicone Co., Ltd. | | |
| | Added Amount of Fine | 20 | 20 | 20 | 20 |
| | Particles [phr] | | | | |
| | Diameter of Fine | about 8 (1-15) | about 8 (1-15) | about 5 (3-7) | about 30 |
| | Particles [μm]: a | | | | |
| | Resin Resistance [Ω cm] | 1.00E+08 | 1.00E+08 | 1.00E+08 | 1.00E+08 |
| | Thickness of Layer [μm]: b | 100 | 100 | 100 | 100 |
| | a/b | 0.08 | 0.08 | 0.05 | 0.30 |
| Physical | Roller Resistance [Ω] | 7 × 10⁷ | 7 × 10⁷ | 7 × 10⁷ | 7 × 10⁷ |
| properties | Rz [μm] | 9 | 7 | 9 | 12 |
| | Hardness [Asker C] | 48 | 49 | 48 | 51 |
| Initial | Charge of toner [μC/g] | 21 | 21 | 18 | 23 |
| Characteristics | Amount of carried toner | 0.3 | 0.3 | 0.3 | 0.3 |
| of Roller | [mg/cm²] | | | | |
| Initial Result of | Image Density | Good | Good | Good | Good |
| image | Fog | None | None | None | None |
| | Density Differential | None | None | None | None |
| | between Top and End | | | | |
| | Half-tone Spots | Good | Good | Good | Good |
| Durability | Abrasion of Roller | None | None | None | None |
| | (After printing 10,000 | | | | |
| | pieces of paper) | | | | |

Note

TABLE 2

| | | Example 5 | Example 6 | Example 7 | Example 8 |
|---|---|---|---|---|---|
| Elastic Layer | Resin | Foamed RIM | Foamed RIM | Foamed RIM | Foamed RIM |
| | | urethane | urethane | urethane | urethane |
| | Resin Resistance [Ω cm] | 1.00E+07 | 1.00E+07 | 1.00E+07 | 1.00E+07 |
| | Thickness [mm] | 4 | 4 | 4 | 4 |
| Resin Outer Layer | Resin | Polyurethane | Polyurethane | Polyurethane | Polyurethane |
| | | Acrylate | Acrylate | Acrylate | Actylate |
| | Conductive Agent | NaClO₄ | NaClO₄ | NaClO₄ | Carbon Black |
| | | 2phr | 2phr | 2phr | 20phr |
| | Fine Particles | Phenol Resin, | Glassy Carbon, | Urethane Resin, | Silicone Rubber, |
| | | BELLPEARL | BELLPEARL | BURNOCK CFB | TOREFILL E- |
| | | S890 from | C800 from | 101-40 from | 500 from Dow |
| | | Kanebo, Ltd. | Kanebo, Ltd. | Dainippon Ink | Corning Toray |
| | | | | and Chemicals, | Silicone Co., Ltd. |
| | | | | Inc. | |
| | Added Amount of Fine | 20 | 20 | 20 | 20 |
| | Particles [phr] | | | | |
| | Diameter of Fine Particles | 20 | 15 | about 8 (5-10) | about 8 (1-15) |
| | [μm]: a | | | | |
| | Resin Resistance [Ω cm] | 1.00E+08 | 1.00E+07 | 1.00E+08 | 1.00E+08 |
| | Thickness of Layer [μm]: b | 100 | 100 | 100 | 100 |
| | a/b | 0.20 | 0.15 | 0.20 | 0.08 |
| Physical | Roller Resistance [Ω] | 7 × 10⁷ | 6 × 10⁷ | 7 × 10⁷ | 5 × 10⁷ |
| properties | Rz [μm] | 10 | 10 | 9 | 9 |
| | Hardness [Asker C] | 51 | 51 | 51 | 48 |
| Initial | Charge of toner [μC/g] | 20 | 15 | 19 | 19 |
| Characteristics | Amount of carried toner | 0.3 | 0.3 | 0.3 | 0.3 |
| of Roller | [mg/cm²] | | | | |
| Initial Result of | Image Density | Good | Good | Good | Good |
| image | Fog | None | None | None | None |
| | Density Differential | None | None | None | None |
| | between Top and End | | | | |
| | Half-tone Spots | Good | Good | Good | Good |
| Durability | Abrasion of Roller (After | None | None | None | None |
| | printing 10,000 pieces of | | | | |
| | paper) | | | | |

| | | |
|---|---|---|
| Note | The glassy Carbon | The layer is cured |
| | has conductivity | by EB |

TABLE 3

| | | Comparative | Comparative | Comparative | Comparative | Comparative |
|---|---|---|---|---|---|---|
| | | Example 1 | Example 2 | Example 3 | Example 4 | Example 5 |
| Elastic Layer | Resin | Foamed RIM | Foamed RIM | Foamed RIM | Foamed RIM | Foamed RIM |
| | | urethane | urethane | urethane | urethane | urethane |
| | Resin Resistance [Ω cm] | 1.00E+07 | 1.00E+07 | 1.00E+07 | 1.00E+07 | 1.00E+07 |
| | Thickness [mm] | 4 | 4 | 4 | 4 | 4 |
| Resin Outer | Resin | Polyurethane | Polyurethane | Polyurethane | Polyurethane | Polyurethane |
| Layer | | Acrylate | Acrylate | Acrylate | Acrylate | Acrylate |
| | Conductive Agent | NaClO₄ | NaClO₄ | NaClO₄ | NaClO₄ | NaClO₄ |
| | | 2phr | 2phr | 2phr | 2phr | 2phr |
| | Fine Particles | None | Silicone Rubber, | Melamine Resin | Phenol Resin, | Glassy Carbon, |
| | | | TOREFILL E-500 | Pulverized Particles | BELLPEARL S890 | BELLPEARL C800 |
| | | | from Dow Corning | | from Kanebo, Ltd. | from Kanebo, Ltd. |
| | | | Toray Silicone Co., | | | |
| | | | Ltd. | | | |
| | Added Amount of Fine | — | 20 | 20 | 120 | 0.05 |
| | Particles [phr] | | | | | |
| | Diameter of Fine | — | 130 | 0.8 | 20 | 15 |
| | Particles [μm]: a | | | | | |
| | Resin Resistance [Ω cm] | 5.00E+06 | 1.00E+08 | 1.00E+08 | 1.00E+10 | 5.00E+06 |
| | Thickness of Layer | 100 | 200 | 100 | 100 | 100 |
| | [μm]: b | | | | | |
| | a/b | — | 0.65 | 0.008 | 0.20 | 0.15 |
| Physical | Roller Resistance [Ω] | 2 × 10⁷ | 1 × 10⁸ | 7 × 10⁷ | 5 × 10⁹ | 2 × 10⁷ |
| properties | Rz [μm] | 3 | 20 | 3 | 22 | 3 |
| | Hardness [Asker C] | 50 | 54 | 52 | 53 | 50 |
| Initial | Charge of toner [μC/g] | 27 | 18 | 25 | 18 | 26 |
| Characteristic | Amount of carried toner | 0.2 | 0.35 | 0.25 | 0.35 | 0.2 |
| | [mg/cm²] | | | | | |
| Initial Result | Image Density | Low | Low | Low | Good | Low |
| of image | Fog | None | Slightly present | None | Present | None |
| | Density Differential | Significant | Significant | Significant | None | Significant |
| | between Top and End | | | | | |
| | Half-tone Spots | None | Slightly present | None | Significantly | None |
| | | | | | present | |
| Durability | Abrasion of Roller (After | Slightly present | Present | Slightly present | Present | Slightly present |
| | printing 10,000 pieces of | | | | | |
| | paper) | | | | | |

| | | | | | |
|---|---|---|---|---|---|
| Note | No fine particles | The fine | The fine | The added amount | The added |
| | are added | particles have | particles have | of fine particles is | amount of fine |
| | | too large | too small | too large, the UV | particles is too |
| | | diameter and the | diameter | resin raw material | small |
| | | layer is too thick | | has high viscosity so | |
| | | | | that it is difficult to | |
| | | | | uniformly apply the | |
| | | | | raw material | |

As described in the above, according to a developing roller of the present invention and an image forming device using the developing roller of the present invention, high-quality image can be securely obtained.

What we claim is:

1. A developing roller comprising a shaft, an elastic layer formed on the outer periphery of the shaft, and at least one resin outer layer formed on the outer periphery of the elastic layer, wherein
fine particles are dispersed in the resin outer layer.

2. A developing roller as claimed in claim 1, wherein the mean particle diameter of the fine particles is in a range of 1 to 50 μm.

3. A developing roller as claimed in claim 1, wherein the content of the fine particles is in a range of 0.1 to 100 parts by weight relative to 100 parts by weight of resin.

4. A developing roller as claimed in claim 1, wherein the thickness of the resin outer layer is in a range of 1 to 100 μm.

5. A developing roller as claimed in claim 1, wherein the ratio of the mean particle diameter “a” of the fine particles and the thickness “b” of the resin outer layer, i.e. “a/b”, is in a range of 0.03 to 0.5.

6. A developing roller as claimed in claim 1, wherein the resin outer layer is made of a ultraviolet-curable resin or an electron-beam-curable resin.

7. A developing roller as claimed in claim 1, wherein the fine particles are fine particles of a rubber or a synthetic resin.

8. A developing roller as claimed in claim 7, wherein the fine particles are fine particles of at least one selected from a group consisting of silicone rubber, fluoroplastic, urethane elastomer, urethane acrylate, melamine resin, and phenol resin.

9. A developing roller as claimed in claim 1, wherein the fine particles are glassy carbon fine particles.

10. A developing roller as claimed in claim 1, wherein the resin outer layer contains a conductive agent.

11. A developing roller as claimed in claim 10, wherein the content of the conductive agent is in a range of 0.01 to 20 parts by weight relative to 100 parts by weight of the resin.

12. A developing roller as claimed in claim 1, wherein the elastic layer is molded in a mold and the resin outer layer is formed without grinding the surface of the elastic layer.

13. An image forming device having a developing roller, wherein the developing roller is the developing roller as claimed in claim 1.
